(19) United States
(12) Patent Application Publication
(10) Pub. No.: US 2007/0143790 A1
(43) Pub. Date: Jun. 21, 2007

(54) System and method for channel selection on a set-top box

(75) Inventors: Alyssa Williams, Elmhurst, IL (US); Brett Anderson, Fair Oaks Ranch, TX (US); Jeff Brandt, Cedar Park, TX (US); James Cansler, Pflugerville, TX (US); Marc Sullivan, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/305,533

(22) Filed: Dec. 16, 2005

(51) Int. Cl. H04N 5/50; H04N 5/44; H04N 5/445; G06F 3/00

(52) U.S. Cl. 725/38; 725/61; 348/731; 348/734

(57) ABSTRACT

A method and system for channel selection on a set-top box is provided. The method includes receiving a channel request from a user control device, wherein the channel request at least one alphabetic letter. The method further includes processing the channel request and mapping the channel request to at least one channel within the available channel list of channels available via the set-top box. Further, and in response to the channel request received, a channel output is provided.

### FIELD OF THE DISCLOSURE

The present disclosure relates to set-top boxes, and in particular to a system for and method of channel selection on a set-top box.

### BACKGROUND

The use of user control devices, such as remote control units and wireless keyboards, to change or select a channel from a number of available multimedia channels on televisions are well known. Multimedia content providers also provide program guides, such as electronic programming guides (EPGs), to subscribers to facilitate navigation, via these user control devices, among the available multimedia channels.

Typically, a remote control unit contains a numeric pad which includes numeric buttons for channel selection and an interactive pad which includes arrow buttons and an Enter button (e.g. the “OK” button) to navigate through the EPG or through the available multimedia channels. A remote control unit typically further includes a navigation pad with buttons relating to navigation features of the multimedia channels (e.g. an EPG key) and a television pad having buttons to control the television volume, television channels and other television features.

Channel selection is typically effected by entering, using the numeric pad of the remote control unit, the specific channel number of the channel the user wants to view (e.g. “52” for ESPN). Alternatively, the user may use the arrow buttons of the interactive pad to scroll through the channels until the required channel is reached. A user may also find the required channel by scrolling through the available channels on the EPG and then selecting the required channel by pressing the Enter button.

However, these methods of channel selection are quite time-consuming and are even more cumbersome when a user does not know the specific channel number associated with the channel of choice.

Accordingly, alternative techniques for selecting and changing multimedia channels and for navigating among multimedia channels would be advantageous.

### BRIEF DESCRIPTION OF THE DRAWINGS

Embodiments are illustrated by way of example and not limitation in the figures of the accompanying drawings, in which:

FIG. 1 is a block diagram representative of a system, according to an example embodiment, over which television content can be sent and received;

FIG. 2 is a simplified flow chart to illustrate general operating logic, according to an example embodiment, that can be used for selecting a channel on a set-top box;

FIG. 3A and FIG. 3B are detailed flow charts to illustrate the general operating logic of FIG. 2 that can be used for selecting a channel on a set-top box, according to example embodiment; and

FIG. 4 is a block diagram representative of a television, showing a menu generated, according to an example embodiment and using predictive entry functionality, in response to a channel request received.

FIG. 5 shows a diagrammatic representation of machine in the example form of a set-top box within which a set of instructions, for causing the machine to perform any one or more of the methodologies discussed herein, may be executed.

FIG. 6 is a diagrammatic representation of a remote control unit, according to an example embodiment, that may be utilized to interact with, and control, a set-top box.

FIG. 7 illustrating an example an Internet Protocol Television (IPTV) environment in which a set-top box, according to an example embodiment, may be deployed, and that may be used to provide video content.

### DETAILED DESCRIPTION OF THE DRAWINGS

A method of selecting a channel on a set-top box is provided. The method includes receiving a channel request from a user control device, wherein the channel request includes at least one alphabetic letter and is a partial or complete alphanumeric channel identifier associated with at least one channel within an available channel list on the set-top box. The available channel list, in one embodiment, identifies channels that are available via the set-top box. The channel request is mapped to at least one channel within the available channel list. In response to the channel request received, a channel output to a display device is provided.

In another example embodiment, a system for channel selection on a set-top box is provided. The system includes a receiver to receive a channel request from a user control device, with the channel request typically including at least one alphabetic letter and is a partial or complete alphanumeric channel identifier associated with a channel within an available channel list on the set-top box. A processor is also provided to map the channel request to at least one channel within the available channel list on the set-top box and to provide a channel output, in response to the channel request received, to a display device.

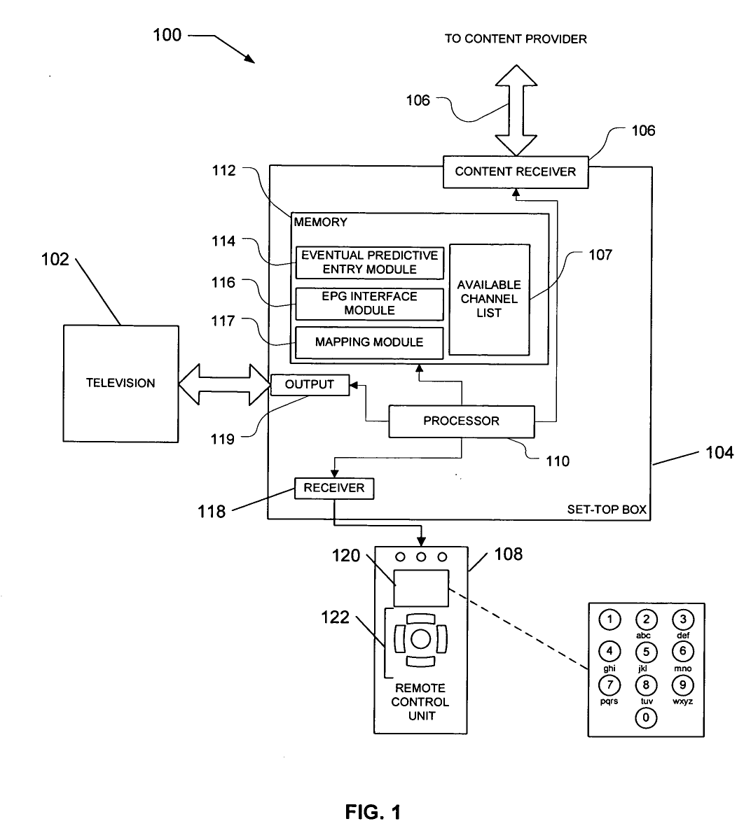

Referring to FIG. 1, a system for managing program content and movies at a television is illustrated and is generally designated 100. As illustrated in FIG. 1, in an example embodiment, the system 100 includes a television 102. However, it will be appreciated that the system can include any display device on which video content can be displayed. FIG. 1 indicates that a set-top box 104 is connected to the television 102. The set-top box 104 is also connected to a content provider, e.g., an IPTV, a cable company or digital satellite service provider, via an appropriate connection 106 (e.g., an Internet or network connection, the cable connection, or a satellite connection). To this end, the set-top box 104 includes a receiver 105 to receive content via the connection 106. As shown in FIG. 1, the system 100 further includes a user input device, such as a remote control unit 108, to allow a user interaction with the system 100 during operation, and in particular to navigate between channels and to ultimately select a channel of choice. The set-top box 104 includes an appropriate receiver 118 (e.g., a radiofrequency receiver) to receive input signals from the remote control unit 108. It will be appreciated that the user input device may also be a keyboard, in particular a wireless keyboard. The receiver 118, e.g., an IR or RF receiver, is configured to receive one or more IR or RF signals from the remote control unit 108. It will be appreciated that the receiver 118 may alternatively be a coaxial cable interface, a wireless interface to send and receive wireless transmissions, or a data packet-based network interface, such as an Ethernet interface.

As indicated in FIG. 1, the set-top box 104 includes a processor 110 in which logic, such as user interface logic, can be executed. Set-top box 104 also includes a memory 112 in which content from the content provider can be downloaded and stored. An available channel list 107, containing, inter alia, (1) information on the various available channels provided by the content provider and available via the set-top box one to reform, (2) associated channel identifiers and (3) associated channel numbers, is also stored in the memory 112. A predictive entry module 114 to generate menus in response to a user input is also included in the set-top box 104.

The memory 112 of the set-top box 104 may further store an electronic programming guide (EPG) interface module 116. The EPG interface module 116 may be implemented as executable instructions stored in memory 112 and executed by the processor 110 of the set-top box 104. Typically, the EPG interface module 116 generates, in combination with the predictive entry module 114, EPG sub-menus, in response to a channel request received.

Also stored within the memory 112 of the set-top box 104 is a mapping module 117 which operationally maps a channel request, received at the receiver 100 from the remote control device 108, to at least one channel identified within the available channel list 107.

FIG. 1 also shows that the set-top box 104 may include an output module 119 to provide a channel output, in response to a channel request received at the receiver 118 from the remote control device 108, to a display device (e.g., the television set 102 or a monitor device).

Turning now to the remote control unit 108, this device may include a number of buttons that can be toggled by a user during operation, e.g., in order to cause one or more video files to be downloaded from the content provider, to navigate between channels or within the EPG, or to send a channel request to the set-top box 104.

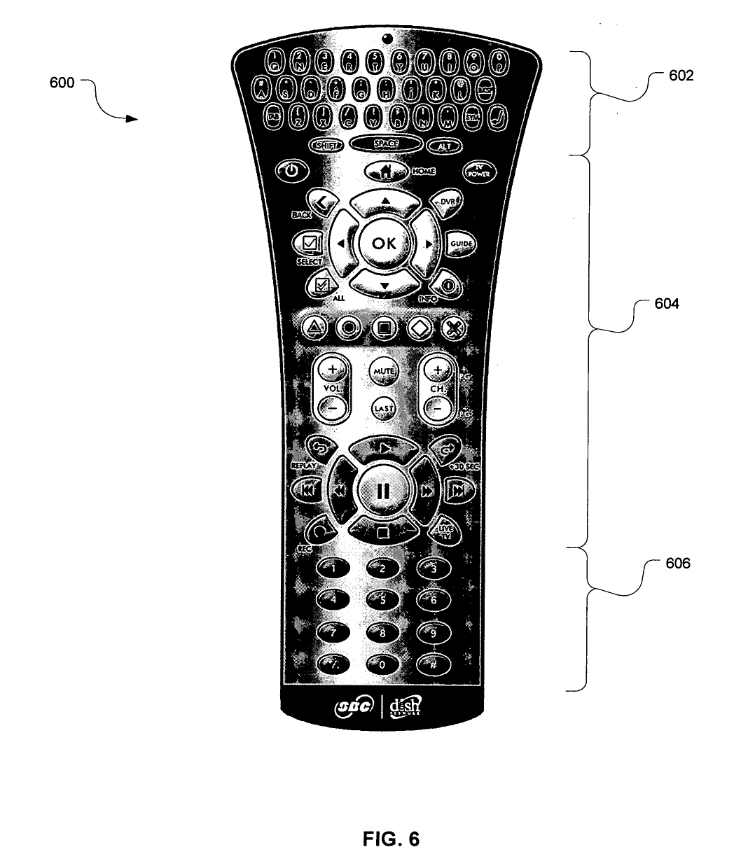

In one embodiment, the remote control unit 108 may include an alphanumeric pad 120 which includes numeric buttons for channel selection, with alphabetic letters either printed on the buttons or next to the buttons. The alphanumeric pad 120 may be similar to the key set of a mobile handset. In an alternative embodiment, the remote control unit 108 may include a separate numeric pad and a separate alphabetic pad. The alphabetic pad may have a QWERTY layout. The alphanumeric pad or alphabetic pad is used to send a channel request to the receiver 118 of the set-top box 104. An example of a remote control 600 unit having separate numeric and alphabetic pads is discussed below with reference to FIG. 6.

In addition to this, the remote control unit 108 may have an interactive pad 122 which includes arrow buttons and an Enter button (e.g. the “OK” button) to navigate through an EPG or through the channels. The remote control unit 108 may further include a navigation pad (not shown) with buttons relating to navigation features of the multimedia channels (e.g. an EPG key) and a television pad (not shown) having buttons to control the television volume, channels and other television features.

The content provider typically receives data representative of multimedia channels from a content source or sources, and provides data representative of at least a subset of the multimedia channels to the set-top box 104 for processing and display at the television 102. The content provider also provides data representative of an EPG to the set-top box 104 for processing by the processor 1 10 and for navigation by a user via the remote control unit 108 and the EPG interface module 116.

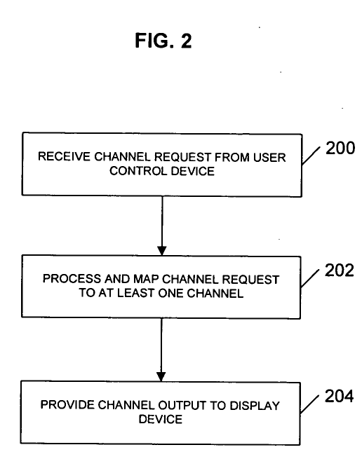

Referring to FIG. 2, an example embodiment of operating logic of the system 100 (FIG. 1) is shown and commences at block 200, wherein, when a channel request is received from the remote control unit 108, the succeeding operations are performed.

The channel request typically comprises a channel identifier or a partial channel identifier. A channel identifier may be any alphanumeric channel identifier including the name of the channel, the alias of the channel or an abbreviation of the name of the channel, e.g. CNN, ESPN or DISCOVERY. Each channel identifier is associated with a multimedia channel within an available channel list of channels on the set-top box 104. The channel identifier comprises at least one alphabetic letter, which letter is typically the first character of the channel identifier.

At block 202, the processor 110 processes the received channel request by accessing data stored in the memory 112. The processor 110 maps the channel request to at least one channel associated with the channel request within the available channel list. In certain circumstances, the processor 110 may map the channel request to a number of channel identifiers. This process is described in more detail below.

In response to the channel request received, a channel output is provided by the processor 110 to the television 102, as shown by block 204. The type of channel output is dependent on the status of the display of the television and/or on the mapping between the channel request and the channels on the available channel list.

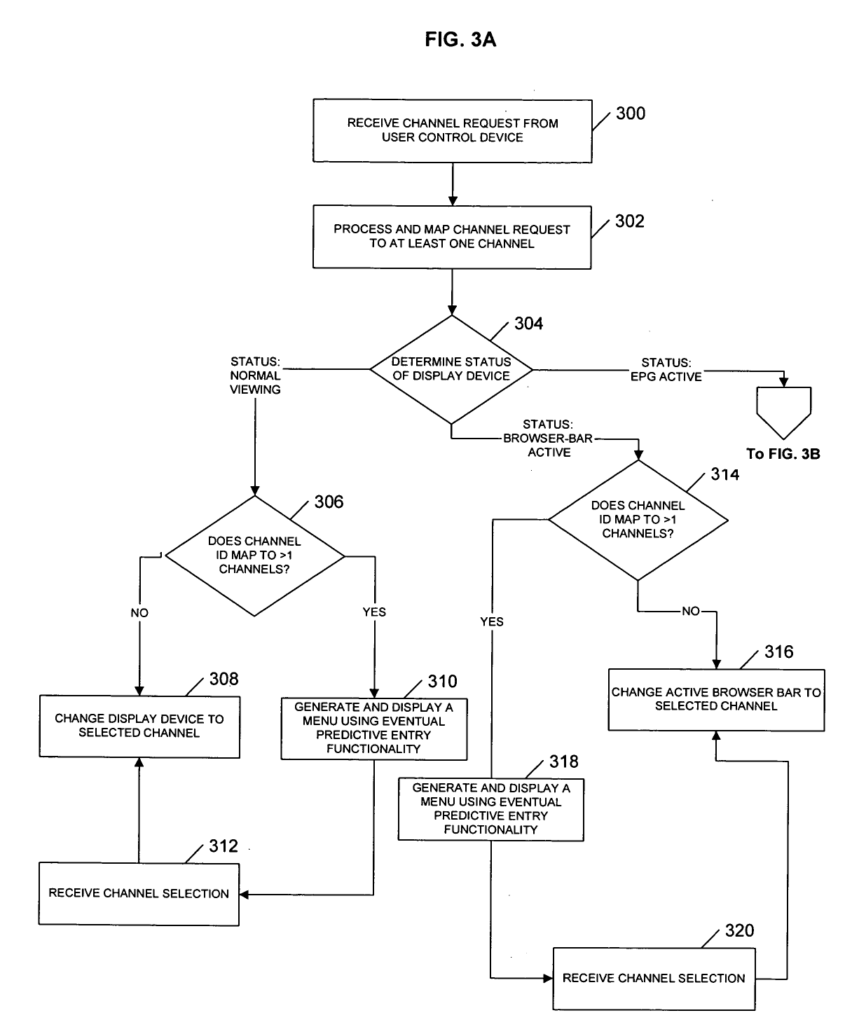

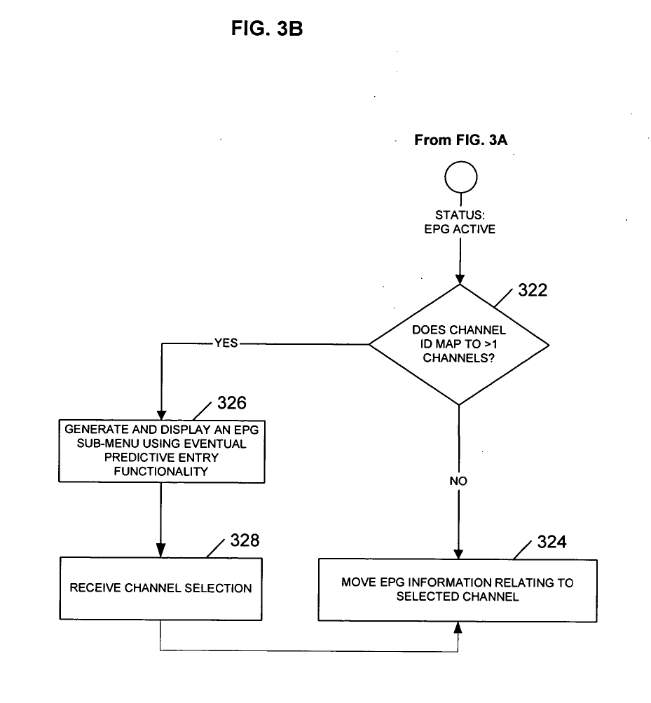

Referring to FIG. 3A, a detailed example embodiment of operating logic of the system 100 (FIG. 1) is shown and commences at block 300. Similar to FIG. 2, when a channel request, as described above, is received from the remote control unit 108, the succeeding operations are performed.

At block 302, the processor 110 processes the received channel request by accessing data stored in the memory 112. The processor 110 maps the channel request to at least one channel associated with the channel request within the available channel list. A channel request is mapped to a particular channel when the channel request is a portion of the channel identifier, typically the first few characters.

The processor 110 now determines the status of the display on the television, as shown in decision block 304. The status of the television 102 is selected from a normal viewing status, a browser-bar active status or an EPG active status.

A normal viewing status is typically when a user is viewing live television, without a mini-guide or browser-bar being active or open, and without the EPG being active.

A browser-bar active status relates to viewing when a mini-guide or browser-bar is active during television service. A browser-bar is a single channel visual display that is generally placed in the bottom quarter of a television screen. The browser-bar allows the user to navigate, typically using the arrow buttons or channel buttons on the remote control 108, to other channels on the browser-bar while remaining on the current channel the user is viewing.

An EPG active status relates to a user viewing and navigating within the EPG, e.g., live television viewing has been suspended, while the user accesses program information from the EPG.

Should the status of the display on the television 102 be that of normal viewing, the processor 110 determines, at block 306, whether the channel request received maps to one or more channels from the available channel list stored in the memory 112.

In the event that the processor 110 maps to only one channel, irrespective of whether the channel request is a complete or partial channel identifier, the display on the television 102 is changed to the selected channel, as shown in block 308. For example, if the user has entered “CNN” using the alphanumeric pad 120 and the processor 110 determines that “CNN” maps to only one channel, that is CNN channel number 54, the viewing channel on the television 102 will be changed to “CNN” channel number 54.

If the processor 110 determines that the channel maps to more than one channel, notwithstanding the channel request being a complete or partial channel identifier, the predictive entry module 114 generates, as shown in block 310, a menu, using predictive entry functionality. The menu lists all channels within the available channel list stored in the memory 112 of the set-top box 104 which have mapped to the received channel request. Therefore, in the event that the received channel request is a partial alphanumeric channel identifier, all channels having the partial alphanumeric channel identifier as part of their respective alphanumeric channel identifiers will be listed in the menu.

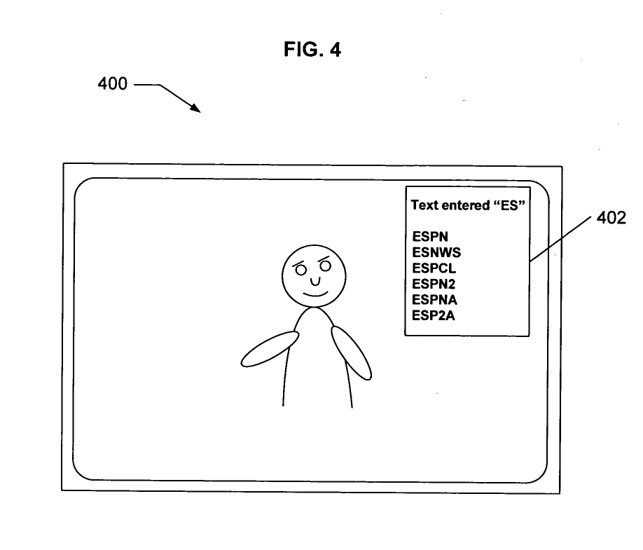

FIG. 4 provides an example of a menu 402 displayed on a television, and illustrates a television 400 that has a normal viewing status, e.g., the television may be on a cartoon network. The set-top box 104 receives a channel request from a user input device 108, where the channel request in this example embodiment is a partial channel identifier, namely “ES”. The menu, 402, is now generated by including in the menu all channel identifiers mapped to the partial channel identifier. That is, all channel identifiers which start with the letters “ES” are listed in the menu.

Returning to FIG. 3A, the set-top box 104 now receives, as shown in block 312, a channel selection from the remote control unit 108. This channel selection is typically effected by a user scrolling through the channels displayed in the menu 402 with the arrow buttons and then pressing the Enter button once on the channel of choice. When the channel selection is received by the receiver 118, the display on the television 102 is changed to the selected channel by the processor 110.

Turning to block 314, in the event that the status of the display on the television 102 is a browser-bar active status, the processor 110 determines whether the channel request received maps to one or more channels in the memory 112. If the processor 110 maps the channel request to only one channel, irrespective of the channel request being a complete or partial channel identifier, the display on the active browser-bar is changed to the selected channel in block 316, which in these circumstances will be the channel associated with and mapped to the complete or partial channel identifier received as channel request.

However, as shown in block 318, if the processor 110 maps the channel request to more than one channel identifier, a browser-bar menu is generated. The browser-bar menu lists all channels within the available channel list stored in the memory 112 of the set-top box 104, which channels have been mapped to the received channel request. As described above, predictive entry functionality is used by the predictive entry module 114 to generate the browser-bar menu. The browser-bar menu typically has the same format as the menu 402 described according to FIG. 4, although the browser-bar menu may have a heading indicating that it is a menu for the browser-bar and not for the main channel.

The set-top box 104 now receives, as shown in block 320, a channel selection from the remote control unit 108. Similar to the description above, this channel selection is effected by a user scrolling through the browser-bar menu with the arrow buttons and then pressing the Enter button when the channel of choice is highlighted or indicated as preferred. Once the channel selection is received by the receiver 118 from the remote control unit 108, the display on the browser-bar of the television 102 is changed to the selected channel, while the display on the remainder of the television screen will remain the same.

Moving from FIG. 3A to FIG. 3B, should the processor 110 determine the status of the display on the television 102 to be an active EPG status, the processor 110 again determines, as shown in block 322, whether the channel request received from the remote control unit 108 maps to one or more channels from the available channel list stored in the memory 112.

As shown in block 324, if it is determined that the channel request maps to only one channel, the processor 110, through the EPG interface module 116, moves the EPG information to the selected channel. Typically, the user's highlight of a particular channel will move to the selected channel identifier and channel number.

Alternatively, if the processor 110 determines that the channel request maps to more than one channel, the EPG interface module 116, together with the processor 110, generates an EPG sub-menu and the processor 111 displays this EPG sub-menu on the television 102. This is illustrated by block 326. The EPG sub-menu may include all the information typically displayed by the EPG, but only for the channels within the available channel list stored in the memory 112 of the set-top box 104 which have mapped to the received channel request. The predictive entry module 114 is responsible for the selection of these channels.

The user may now navigate within the EPG sub-menu by using the arrow buttons and Enter button to scroll up and down the sub-menu. Further, utilizing the EPG sub-menu, the user may perform a channel selection that is received by the set-top box one of the reform at block 328, whereafter the method again progresses to block 324. This channel selection is typically effected by a user scrolling through the channels displayed in the EPG sub-menu with the arrow buttons and then pressing the Enter button once on the channel of choice. When the channel selection is received by the receiver 118, the display on the television 102 of the EPG information may be moved to the selected channel.

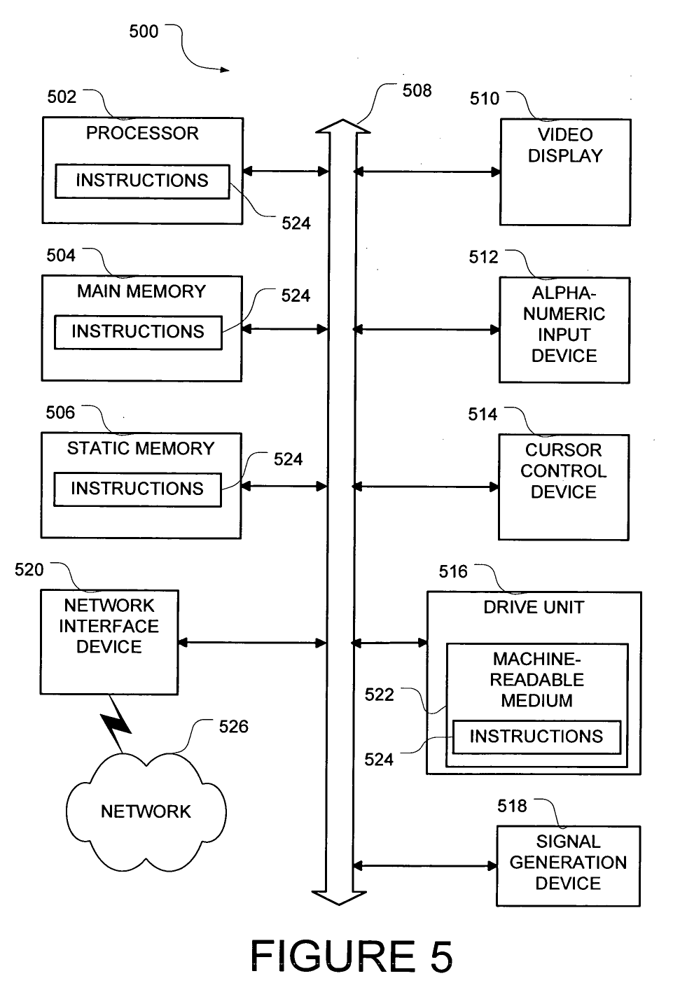

FIG. 5 shows a diagrammatic representation of machine in the example form of a set-top box 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a digital video recorder (DVR), a personal video recorder (PVR), a Personal Digital Assistant (PDA), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example set-top box 500 includes a processor 502 (e.g., a central processing unit (CPU), a graphics processing unit (GPU) or both), a main memory 504 and a static memory 506, which communicate with each other via a bus 508. The set-top box 500 may further include a video display unit 510 (e.g., a liquid crystal display (LCD) or a cathode ray tube (CRT)). The set-top box 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the set-top box 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

FIG. 6 is a diagrammatic representation of a remote control unit 600, according to an example embodiment, that may be utilized to interact with, and control, a set-top box. The remote control unit 600 is shown to include an alphabetic pad 602 composed of alphabetic keys arranged in a QWERTY layout, and having associated “shift” and “alternative” function keys. These keys are selectable to enable the keys of the alphabetic pad 602 to be utilized for the input of numeric data, for example. The center portion 604 of the remote control unit 600 includes a number of navigational and control buttons (e.g., channel selection, volume control, fast forward, rewind, program guide etc.). A numeric pad 606 occupies a lower portion of the remote control unit 600, and is composed of keys that have exclusively numeric input functions.

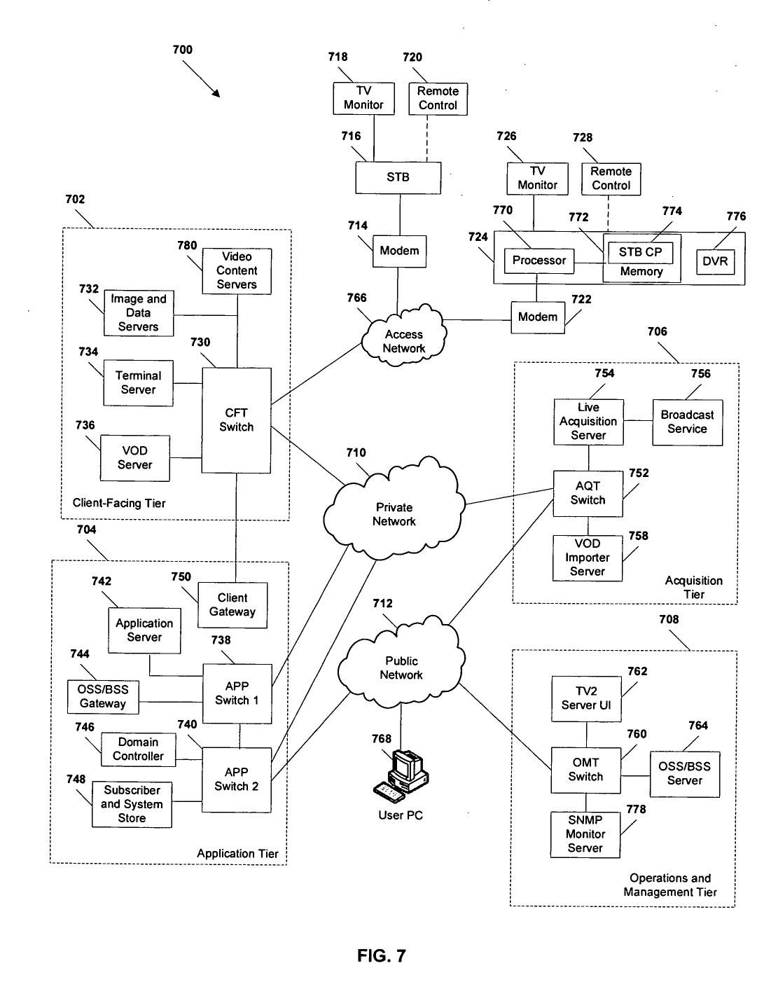

FIG. 7 illustrating an example an Internet Protocol Television (IPTV) environment 700 in which the set-top box 704 described above may be deployed, and that may be used to provide video content. For example, the available channel list 707 may list channels that are made available within the IPTV environment 700. Further, certain of the modules described herein may reside in the locally on a set-top box 104 (as described above), or may reside remotely on a server, to provide the above described functionality to a set-top box 104 within the IPTV environment 700.

As shown, the system 700 can include a client facing tier 702, an application tier 704, an acquisition tier 706, and an operations and management tier 708. Each tier 702, 704, 706, 708 is coupled to a private network 710; to a public network 712, such as the Internet; or to both the private network 710 and the public network 712. For example, the client-facing tier 702 can be coupled to the private network 710. Further, the application tier 704 can be coupled to the private network 710 and to the public network 712. The acquisition tier 706 can also be coupled to the private network 710 and to the public network 712. Additionally, the operations and management tier 708 can be coupled to the public network 712.

As illustrated in FIG. 7, the various tiers 702, 704, 706, 708 communicate with each other via the private network 710 and the public network 712. For instance, the client-facing tier 702 can communicate with the application tier 704 and the acquisition tier 706 via the private network 710. The application tier 704 can also communicate with the acquisition tier 706 via the private network 710. Further, the application tier 704 can communicate with the acquisition tier 706 and the operations and management tier 708 via the public network 712. Moreover, the acquisition tier 706 can communicate with the operations and management tier 708 via the public network 712. In a particular embodiment, elements of the application tier 704, including, but not limited to, a client gateway 750, can communicate directly with the client-facing tier 702.

As illustrated in FIG. 7, the client-facing tier 702 can communicate with user equipment via a private access network 766, such as an Internet Protocol Television (IPTV) access network. In an illustrative embodiment, modems, such as a first modem 714 and a second modem 722 can be coupled to the private access network 766. The client-facing tier 702 can communicate with a first representative set-top box device 716 via the first modem 714 and with a second representative set-top box device 724 via the second modem 722. The client-facing tier 702 can communicate with a large number of set-top boxes, such as the representative set-top boxes 716, 724, over a wide geographic area, such as a regional area, a metropolitan area, a viewing area, a designated market area or any other suitable geographic area, market area, or subscriber or customer group that can be supported by networking the client-facing tier 702 to numerous set-top box devices. In an illustrative embodiment, the client-facing tier, or any portion thereof, can be included at a video head-end office.

In a particular embodiment, the client-facing tier 702 can be coupled to the modems 714, 722 via fiber optic cables. Alternatively, the modems 714 and 722 can be digital subscriber line (DSL) modems that are coupled to one or more network nodes via twisted pairs, and the client-facing tier 702 can be coupled to the network nodes via fiber-optic cables. Each set-top box device 716, 724 can process data received via the private access network 766, via an IPTV software platform, such as Microsoft® TV IPTV Edition.

Additionally, the first set-top box device 716 can be coupled to a first external display device, such as a first television monitor 718, and the second set-top box device 724 can be coupled to a second external display device, such as a second television monitor 726. Moreover, the first set-top box device 716 can communicate with a first remote control 720, and the second set-top box device can communicate with a second remote control 728.

In an exemplary, non-limiting embodiment, each set-top box device 716, 724 can receive video content, which may include video and audio portions, from the client-facing tier 702 via the private access network 766. The set-top boxes 716, 724 can transmit the video content to an external display device, such as the television monitors 718, 726. Further, the set-top box devices 716, 724 can each include a STB processor, such as STB processor 770, and a STB memory device, such as STB memory 772, which is accessible to the STB processor 770. In one embodiment, a computer program, such as the STB computer program 774, can be embedded within the STB memory device 772. Each set-top box device 716, 724 can also include a video content storage module, such as a digital video recorder (DVR) 776. In a particular embodiment, the set-top box devices 716, 724 can communicate commands received from the remote control devices 720, 728 to the client-facing tier 702 via the private access network 766.

In an illustrative embodiment, the client-facing tier 702 can include a client-facing tier (CFT) switch 730 that manages communication between the client-facing tier 702 and the private access network 766 and between the client-facing tier 702 and the private network 710. As shown, the CFT switch 730 is coupled to one or more image and data servers 732 that store still images associated with programs of various IPTV channels. The image and data servers 732 can also store data related to various channels, e.g., types of data related to the channels and to programs or video content displayed via the channels. In an illustrative embodiment, the image and data servers 732 can be a cluster of servers, each of which can store still images, channel and program-related data, or any combination thereof. The CFT switch 730 can also be coupled to a terminal server 734 that provides terminal devices with a connection point to the private network 710. In a particular embodiment, the CFT switch 730 can also be coupled to a video-on-demand (VOD) server 736 that stores or provides VOD content imported by the IPTV system 700. The client-facing tier 702 can also include one or more video content servers 780 that transmit video content requested by viewers via their set-top boxes 716, 724. In an illustrative, non-limiting embodiment, the video content servers 780 can include one or more multicast servers.

As illustrated in FIG. 7, the application tier 704 can communicate with both the private network 710 and the public network 712. The application tier 704 can include a first application tier (APP) switch 738 and a second APP switch 740. In a particular embodiment, the first APP switch 738 can be coupled to the second APP switch 740. The first APP switch 738 can be coupled to an application server 742 and to an OSS/BSS gateway 744. In a particular embodiment, the application server 742 can provide applications to the set-top box devices 716, 724 via the private access network 766, which enable the set-top box devices 716, 724 to provide functions, such as display, messaging, processing of IPTV data and VOD material, etc. In a particular embodiment, the OSS/BSS gateway 744 includes operation systems and support (OSS) data, as well as billing systems and support (BSS) data. In one embodiment, the OSS/BSS gateway can provide or restrict access to an OSS/BSS server 764 that stores operations and billing systems data.

Further, the second APP switch 740 can be coupled to a domain controller 746 that provides web access, for example, to users via the public network 712. For example, the domain controller 746 can provide remote web access to IPTV account information via the public network 712, which users can access using their personal computers 768. The second APP switch 740 can be coupled to a subscriber and system store 748 that includes account information, such as account information that is associated with users who access the system 700 via the private network 710 or the public network 712. In a particular embodiment, the application tier 704 can also include a client gateway 750 that communicates data directly with the client-facing tier 702. In this embodiment, the client gateway 750 can be coupled directly to the CFT switch 730. The client gateway 750 can provide user access to the private network 710 and the tiers coupled thereto.

In a particular embodiment, the set-top box devices 716, 724 can access the IPTV system 700 via the private access network 766, using information received from the client gateway 750. In this embodiment, the private access network 766 can provide security for the private network 710. User devices can access the client gateway 750 via the private access network 766, and the client gateway 750 can allow such devices to access the private network 710 once the devices are authenticated or verified. Similarly, the client gateway 750 can prevent unauthorized devices, such as hacker computers or stolen set-top box devices from accessing the private network 710, by denying access to these devices beyond the private access network 766.

For example, when the first representative set-top box device 716 accesses the system 700 via the private access network 766, the client gateway 750 can verify subscriber information by communicating with the subscriber and system store 748 via the private network 710, the first APP switch 738, and the second APP switch 740. Further, the client gateway 750 can verify billing information and status by communicating with the OSS/BSS gateway 744 via the private network 710 and the first APP switch 738. In one embodiment, the OSS/BSS gateway 744 can transmit a query across the first APP switch 738, to the second APP switch 740, and the second APP switch 740 can communicate the query across the public network 712 to the OSS/BSS server 764. After the client gateway 750 confirms subscriber and/or billing information, the client gateway 750 can allow the set-top box device 716 access to IPTV content and VOD content. If the client gateway 750 cannot verify subscriber information for the set-top box device 716, e.g., because it is connected to an unauthorized twisted pair, the client gateway 750 can block transmissions to and from the set-top box device 716 beyond the private access network 766.

As indicated in FIG. 7, the acquisition tier 706 includes an acquisition tier (AQT) switch 752 that communicates with the private network 710. The AQT switch 752 can also communicate with the operations and management tier 708 via the public network 712. In a particular embodiment, the AQT switch 752 can be coupled to a live acquisition server 754 that receives television or movie content, for example, from a broadcast service 756. In a particular embodiment during operation of the IPTV system, the live acquisition server 754 can acquire television or movie content. The live acquisition server 754 can transmit the television or movie content to the AQT switch 752, and the AQT switch 752 can transmit the television or movie content to the CFT switch 730 via the private network 710.

Further, the television or movie content can be transmitted to the video content servers 780, where it can be encoded, formatted, stored, or otherwise manipulated and prepared for communication to the set-top box devices 716, 724. The CFT switch 730 can communicate the television or movie content to the modems 714, 722 via the private access network 766. The set-top box devices 716, 724 can receive the television or movie content via the modems 714, 722, and can transmit the television or movie content to the television monitors 718, 726. In an illustrative embodiment, video or audio portions of the television or movie content can be streamed to the set-top box devices 716, 724.

Further, the AQT switch can be coupled to a video-on-demand importer server 758 that stores television or movie content received at the acquisition tier 706 and communicates the stored content to the VOD server 736 at the client-facing tier 702 via the private network 710. Additionally, at the acquisition tier 706, the video-on-demand (VOD) importer server 758 can receive content from one or more VOD sources outside the IPTV system 700, such as movie studios and programmers of non-live content. The VOD importer server 758 can transmit the VOD content to the AQT switch 752, and the AQT switch 752, in turn, can communicate the material to the CFT switch 730 via the private network 710. The VOD content can be stored at one or more servers, such as the VOD server 736.

When user issue requests for VOD content via the set-top box devices 716, 724, the requests can be transmitted over the private access network 766 to the VOD server 736, via the CFT switch 730. Upon receiving such requests, the VOD server 736 can retrieve the requested VOD content and transmit the content to the set-top box devices 716,124 across the private access network 766, via the CFT switch 730. The set-top box devices 716, 724 can transmit the VOD content to the television monitors 718, 726. In an illustrative embodiment, video or audio portions of VOD content can be streamed to the set-top box devices 716, 724.

FIG. 7 further illustrates that the operations and management tier 708 can include an operations and management tier (OMT) switch 760 that conducts communication between the operations and management tier 708 and the public network 712. In the embodiment illustrated by FIG. 7, the OMT switch 760 is coupled to a TV2 server 762. Additionally, the OMT switch 760 can be coupled to an OSS/BSS server 764 and to a simple network management protocol (SNMP) monitor 770 that monitors network devices within or coupled to the IPTV system 700. In a particular embodiment, the OMT switch 760 can communicate with the AQT switch 752 via the public network 712.

In an illustrative embodiment, the live acquisition server 754 can transmit the television or movie content to the AQT switch 752, and the AQT switch 752, in turn, can transmit the television or movie content to the OMT switch 760 via the public network 712. In this embodiment, the OMT switch 760 can transmit the television or movie content to the TV2 server 762 for display to users accessing the user interface at the TV2 server 762. For example, a user can access the TV2 server 762 using a personal computer (PC) 768 coupled to the public network 712.

What is claimed is:

1. A method of selecting a channel on a set-top box, the method comprising:
receiving a channel request from a user control device, wherein the channel request includes at least one alphabetic letter;
mapping the channel request to at least one channel within an available channel list on the set-top box; and
providing a channel output in response to the channel request.

2. The method of claim 1, including determining a status of a display on a display device to which the channel output is provided.

3. The method of claim 2, wherein the status of the display on the display device is selected from a normal viewing status, a browser-bar active status or an electronic programming guide (EPG) active status.

4. The method of claim 3, wherein, in response to determining a normal viewing status for the display on the display device and where the channel request maps to a single alphanumeric channel identifier for a first channel within the available channel list, the operation of providing a channel output includes:
changing the display on the display device to the first channel.

5. The method of claim 3, wherein, in response to determining a normal viewing status for the display on the display device and where the channel request maps to respective alphanumeric channel identifiers of a plurality of channels within the available channel list, the operation of providing a channel output includes:
generating a menu, using predictive entry functionality, listing the plurality of channels within the available channel list which have the received channel request as part of their respective alphanumeric channel identifiers; and
displaying the menu on the display device.

6. The method of claim 5, including:
receiving a channel selection from a user control device to select one of the plurality of channels listed on the menu; and
changing the display on the display device to the channel selected by the received channel selection.

7. The method of claim 3, wherein, in response to determining a browser-bar active status for the display on the display device and where the channel request maps to a single alphanumeric channel identifier for a first channel within the available channel list, the operation of providing the channel output includes:
changing the output of an active browser-bar to the first channel.

8. The method of claim 3, wherein, in response to determining a browser-bar active status for the display on the display device and where the channel request maps to respective alphanumeric channel identifiers for a plurality of channels within the available channel list, the operation of providing the channel output includes:
generating a browser-bar menu, using predictive entry functionality, listing the plurality of channels within the available channel list which have the received channel request as part of their respective alphanumeric channel identifiers; and
displaying the browser-bar menu on the display device.

9. The method of claim 8, including:
receiving a channel selection from a user control device to select one of the plurality of channels listed on the browser-bar menu; and
changing the display on the active browser-bar of the display device to the channel selected by the received channel selection.

10. The method of claim 3, wherein, in response to determining an EPG active status for the display on the display device and where the channel request maps to a single alphanumeric channel identifier for a first channel within the available channel list, the operation of providing a channel output includes:
moving the EPG guide to information relating to the first channel.

11. The method of claim 3, wherein, in response to determining an EPG active status for the display on the display device and where the channel request maps to respective alphanumeric channel identifiers for a plurality of channels within the available channel list, the operation of providing a channel output includes:
generating an EPG sub-menu, using predictive entry functionality, listing the plurality of channels and their associated EPG information within the available channel list which have the received channel request as part of their respective alphanumeric channel identifiers; and
displaying the EPG sub-menu on the display device.

12. The method of claim 1 wherein the user control device is at least one of a remote control unit, keyboard and an input device with alphabetic key functionality.

13. The method of claim 1 wherein the output device is at least one of a television set and an electronic display device.

14. A channel selection system comprising:
a receiver to receive a channel request from a user control device, wherein the channel request includes at least one alphabetic letter;
a mapping module to map the channel request to at least one channel within an available channel list of channels available via a set-top box; and
an output module to provide a channel output, in response to the channel request.

15. The system of claim 14, wherein the output module is to determine a status of a display on the display device to which the channel output is provided.

16. The system of claim 15, wherein the status of the display on the display device is selected from a normal viewing status, a browser-bar active status or an electronic programming guide (EPG) active status.

17. The system of claim 14, including an predictive entry module to generate, in response to the channel request being mapped to a plurality of channels within the available channel list, a menu listing channels within the available channel list which have the at least one alphabetic letter of the received channel request as part of their respective alphanumeric channel identifiers.

18. The system of claim 17, including an electronic programming guide (EPG) interface module to generate, in combination with the predictive entry module, an EPG sub-menu.

19. A machine-readable medium storing a set of instructions that, when executed by a machine, cause the machine to:
receiving a channel request from a user control device, wherein the channel request includes at least one alphabetic letter;
mapping the channel request to at least one channel within the available channel list of channels available via the set-top box; and
providing a channel output in response to the channel request.

20. A system to select a channel on a set-top box, the system comprising:
first means for receiving a channel request from a user control device, wherein the channel request includes at least one alphabetic letter;
second means for mapping the channel request to at least one channel within an available channel list of channels available via the set-top box ; and
third means for providing, in response to the channel request received, a channel output to a display device.

21. The system of claim 20, including fourth means for generating, in response to the channel request being mapped to a plurality of channels within the available channel list, a menu listing the plurality of channels within the available channel list which have the at least one alphabetic letter of the received channel request as part of their respective alphanumeric channel identifiers.
